(19) United States
(12) Patent Application Publication
(10) Pub. No.: US 2005/0177415 A1
(43) Pub. Date: Aug. 11, 2005

(54) Business analysis and management systems utilizing emergent structures

(76) Inventors: Michael M. Mann, Palos Verdes Estates, CA (US); Arne Haugland, Pleasanton, CA (US)

Correspondence Address: FULWIDER PATTON LEE & UTECHT, LLP;HOWARD HUGHES CENTER, 6060 CENTER DRIVE, TENTH FLOOR, LOS ANGELES, CA, 90045, US

(21) Appl. No.: 10/959,640

(22) Filed: Oct. 7, 2004

Related U.S. Application Data
(63) Continuation of application No. 10/679,253, filed on Oct. 3, 2003.
(60) Provisional application No. 60/417,018, filed on Oct. 8, 2002.

(51) Int. Cl. G06F 17/60; G06F 7/00

(52) U.S. Cl. 705/11

(57) ABSTRACT

The emergent structure analysis of the present invention enhances a computer-supported tool for improved enterprise process analysis and change management. The new and improved system and method of the present invention collects data on the patterns of interaction among people in an organization, analyzes these relationships with respect to specific organizational processes and issues, and presents the results in a graphical format useful for business management organization decisions. The emergent structure analysis is a selection and transformation process. Its data are the issues that have been defined as important for an organizational or system study and the organization members' reported perceptions of their regular interactions with others about those issues, as gathered by a specialized data collection instrument. According to criteria defined by an analyst using appropriate software in accordance with the invention, the process selects a subset of this raw data, creates a suitable structure, and connects each person record to its appropriate level in the structure.

### CROSS-REFERENCE TO RELATED APPLICATION

This application is claiming the benefit of a co-pending provisional application Ser. No. 60/417,018 filed on Oct. 8, 2002. The material of this related application is incorporated by reference herein. This application is being concurrently filed with a related utility application entitled BUSINESS ANALYSIS AND MANAGEMENT SYSTEMS UTILIZING ENTERPRISE METRICS co-pending from provisional application Ser. No. 60/417,098.

A Compact Disc-Recordable (CD-R) which includes a computer program listing is submitted with this application, since the computer program listing has over 300 lines of code. The material on the CD-R is also incorporated by reference herein.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

This invention relates generally to enhanced business analysis, evaluation and management systems and, more particularly, to improvements in such systems where increased accuracy, efficiency and effectiveness is achieved in the analysis of complex interactive system/organizational relationships and environments through the use of emergent structures generated via the practice of the invention.

2. Description of Related Art

There has been a long existing need in the business world for various methods and means for enhancing organizational processes and dealing with relevant organizational issues to achieve effective management in ever changing, complex, interactive systems and environments. Unfortunately, efforts to date in attempting to efficiently and effectively deal with relevant issues and relationships in such organizations have met with little success. Accordingly, the present invention obviates the disadvantages of such prior efforts and achieves unprecedented success where other approaches have heretofore failed.

### SUMMARY OF THE INVENTION

The emergent structure analysis of the present invention enhances a computer-supported tool for improved enterprise process analysis and change management. The new and improved system and method of the present invention collects data on the patterns of interaction among people in an organization, analyzes these relationships with respect to specific organizational processes and issues, and presents the results in a graphical format useful for business management organization decisions.

The emergent structure analysis is a selection and transformation process. Its data are the issues that have been defined as important for an organizational or system study and the organization members' reported perceptions of their regular interactions with others about those issues, as gathered by a specialized data collection instrument. According to criteria defined by an analyst using appropriate software in accordance with the invention, the process selects a subset of this raw data, creates a suitable structure, and connects each person record to its appropriate level in the structure.

More particularly, by way of example and not necessarily by way of limitation, the invention provides a basic system and method for visualizing interaction patterns, called the issue view. Rather than a fixed, formal hierarchy, this view displays interactions between members of an organization against the background of an emergent structure: that is, which arises from the significance that individual members assign to one another—specifically, their perceived impact on a given issue. In this view, a person's status may be quite different from his position in the organization's formal hierarchy and the view provides valuable insights into the real communication and decision-making patterns within an organization. The emergent structure analysis of the present invention is the system and set of business method procedures that creates these structures.

The standard issue emergent structure view presents a “virtual hierarchy” which emerges around a single issue: people in the organization appear at different levels depending on their perceived impact on that issue. It is often useful, however, to view and compare the emergent structures of more than one issue at the same time. For example, an analyst might want to see who are a company's important decision-making figures in the arenas of both sales and marketing, and investigate the communications links between those groups. To include multiple issues in the same view, practice of the invention provides the ability to create meta-issues. When the analyst wishes to study multiple issues, he or she creates a meta-issue entry in the database and manually connects the related master issues to it.

A “Show Duplicate Nodes” function is also provided and isolates any objects that appear more than once in the issue view display. This feature is useful when examining multiple-issue analyses involving meta-issues, where it is often important to verify that decision-making processes are well integrated across related issues. For example, the same decision-makers may need to be involved in both product design and cost planning. Conversely, in other cases, it may be advisable to ensure that the same individuals do not play a role in areas that should remain separate, such as corporate auditing and investment management.

When studying communication patterns among a group of people, an important concept is that of closeness: the distance between any two individuals, as expressed by the number of nodes between them. For the analyst, this measure reveals how closely two specific members of an organization are linked on a given issue—whether they communicate with each other directly, indirectly through intermediaries, or not at all. Unnecessary steps in the process can represent opportunities for information to be delayed or distorted, whereas direct communications that inappropriately bypass the chain of command and leave others “out of the loop” can subvert the aims of the organizational structure.

In many cases, a complex or crowded display can obscure the links between specific people Furthermore, they may be connected by multiple routes, some more direct than others, so that it becomes difficult to locate the shortest path between them. To find this information, the invention provides the Closeness function, which automatically calculates the displays the shortest path between any two nodes in the graphical analysis tree provided by the invention. Once the program has determined the shortest path between two nodes, the analyst can elect to subtract all other links from the display, thereby isolating the desired path.

All of the above and other features of the invention are facilitated by appropriate EnCompass® software for providing/enabling the functions in the illustrated and equivalent embodiments to “make it happen” in achieving new and improved business analysis and management systems utilizing emergent structures. “EnCompass®” is a registered trademark of EnCompass Knowledge Systems, Inc., Los Angeles, Calif., the company which has pioneered innovative tools for analysis of interactive relationships and organization/system dynamics.

These and other objects and advantages of the invention will become apparent from the following more detailed description, when taken in conjunction with the accompanying drawings of illustrative embodiments.

### BRIEF DESCRIPTION OF THE DRAWINGS

FIG. 1 is a table of project issues for use in the practice of the present invention;

FIG. 2 is a data collection instrument in tabular format;

FIG. 3 is a data collection record for general data;

FIG. 4 is a data collection record for issue-specific data;

FIG. 5 illustrates data collection links;

FIG. 6 illustrates data-collection links with organization structure;

FIG. 7 illustrates an emergent structure, in accordance with the invention;

FIG. 8 illustrates a meta-issue display;

FIG. 9 illustrates duplicate nodes;

FIG. 10 is a display illustrating closeness;

FIG. 11 illustrates closeness with shortest path isolated;

FIG. 12 is a diagram illustrating emergent structure objects;

FIG. 13 illustrates a model 1 query selection;

FIG. 14 illustrates a show results panel;

FIG. 15 shows a master and slave issue tree;

FIG. 16 shows a replace existing connections option;

FIG. 17 illustrates a Parasol application structure;

FIG. 18 is an emergent structure display: 3D view; and

FIG. 19 is an emergent structure display: outline view.

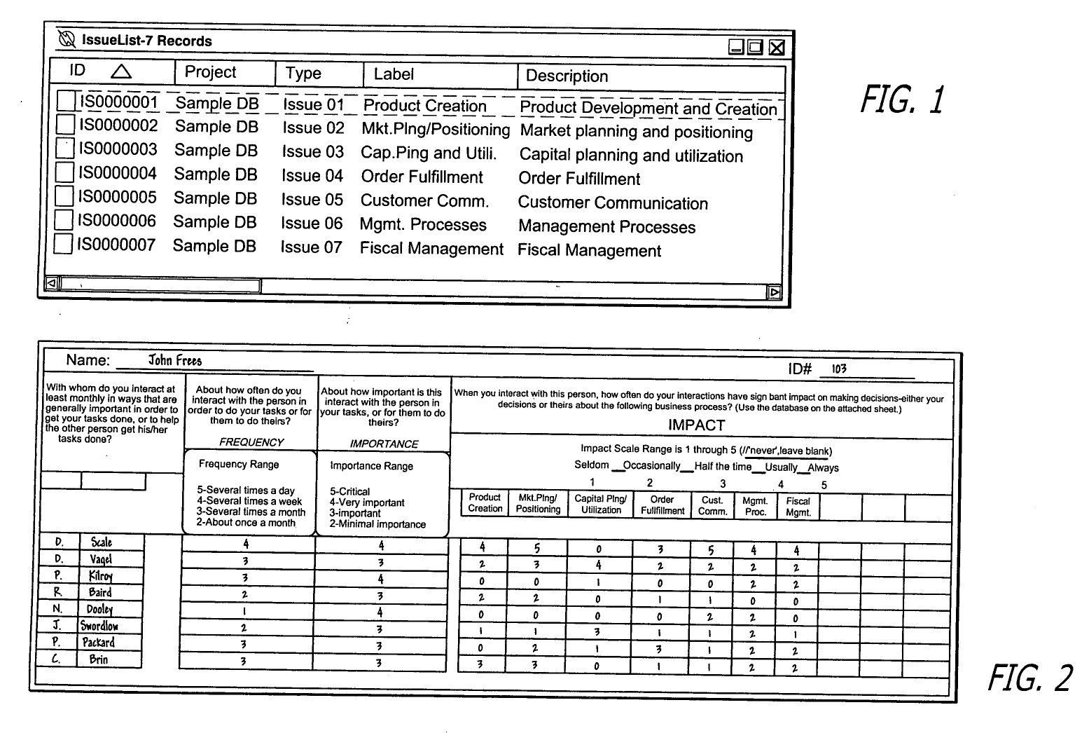

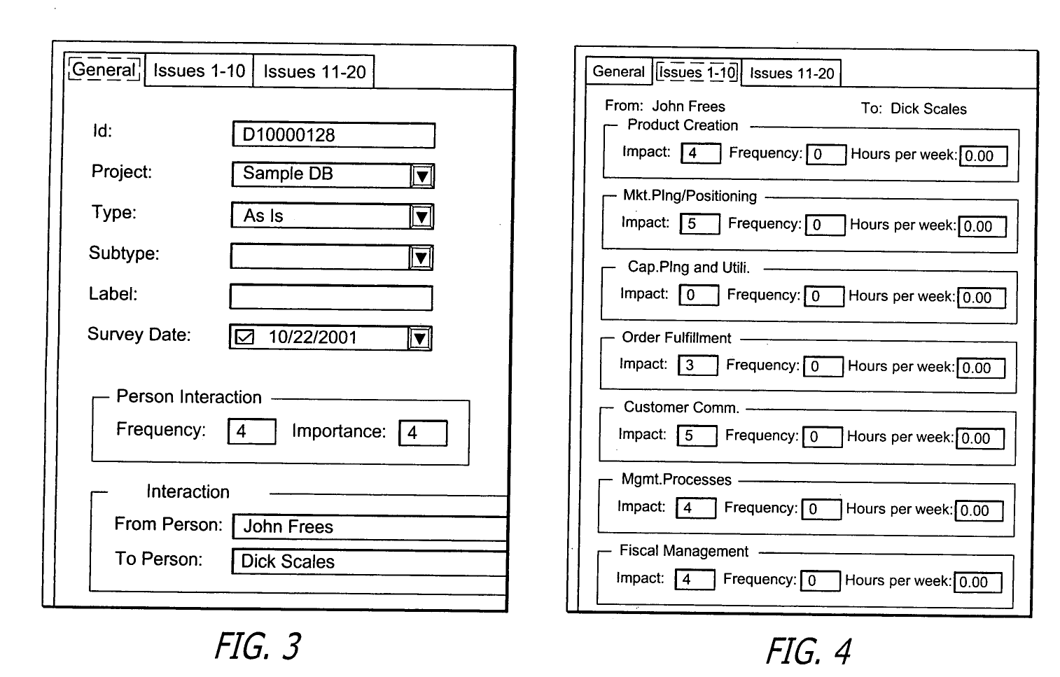

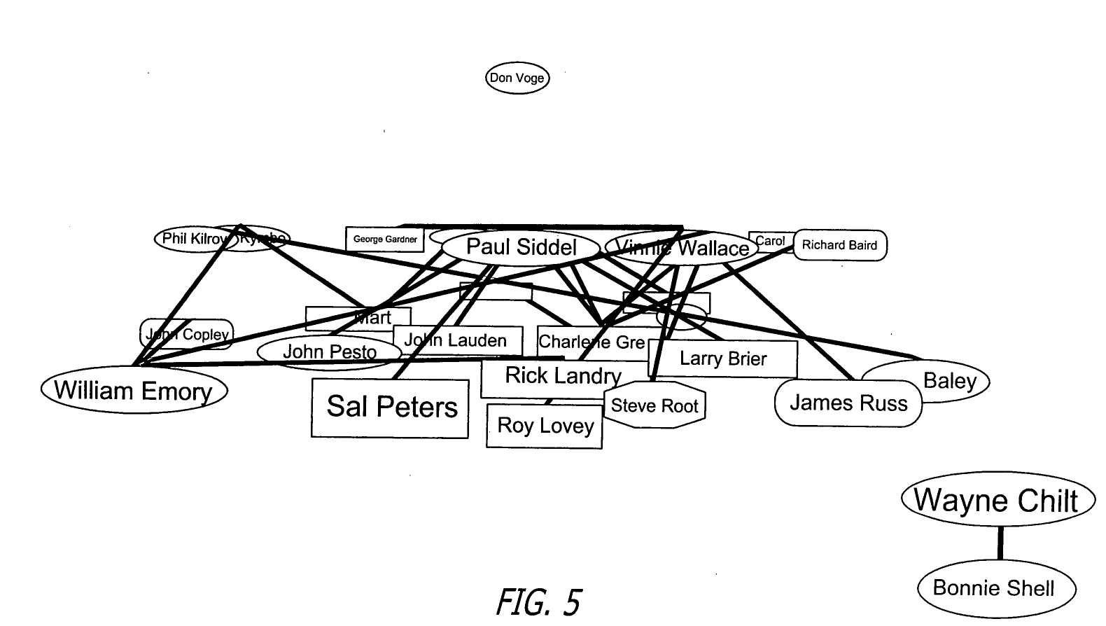

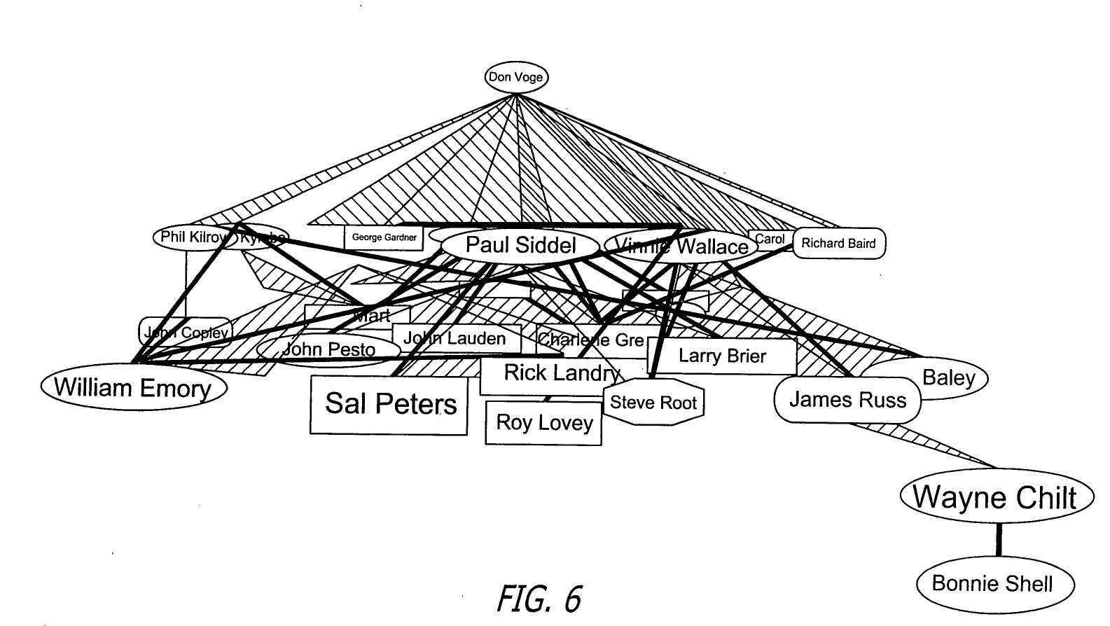

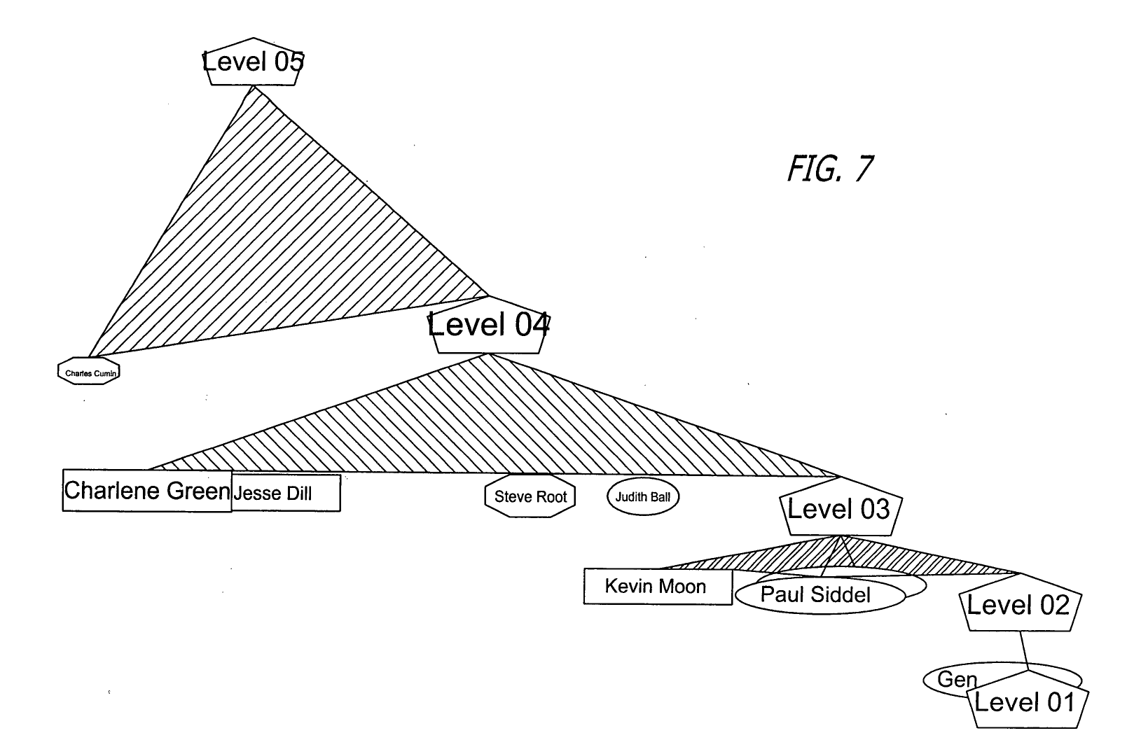

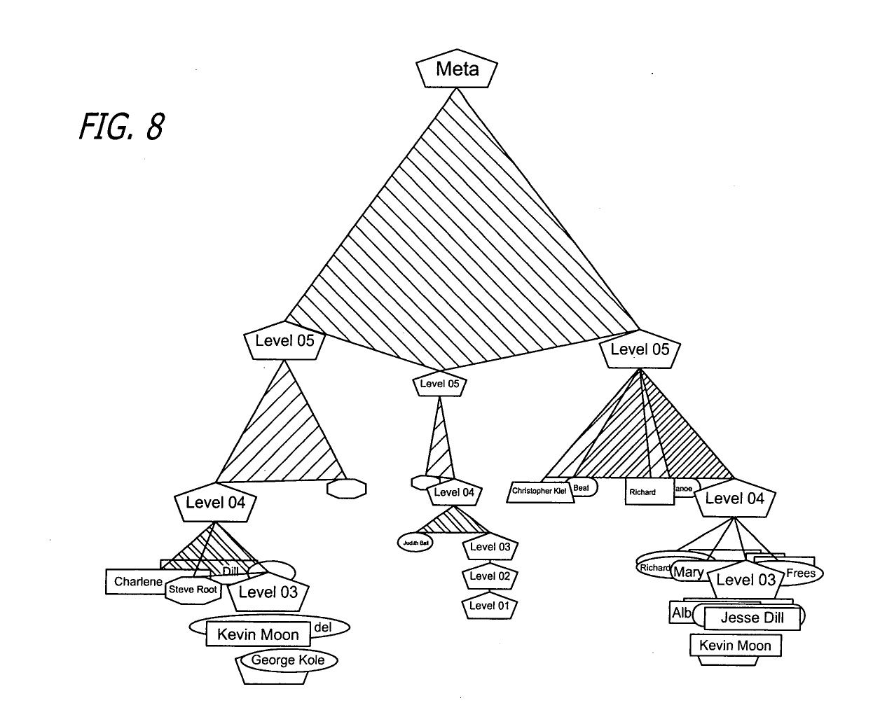

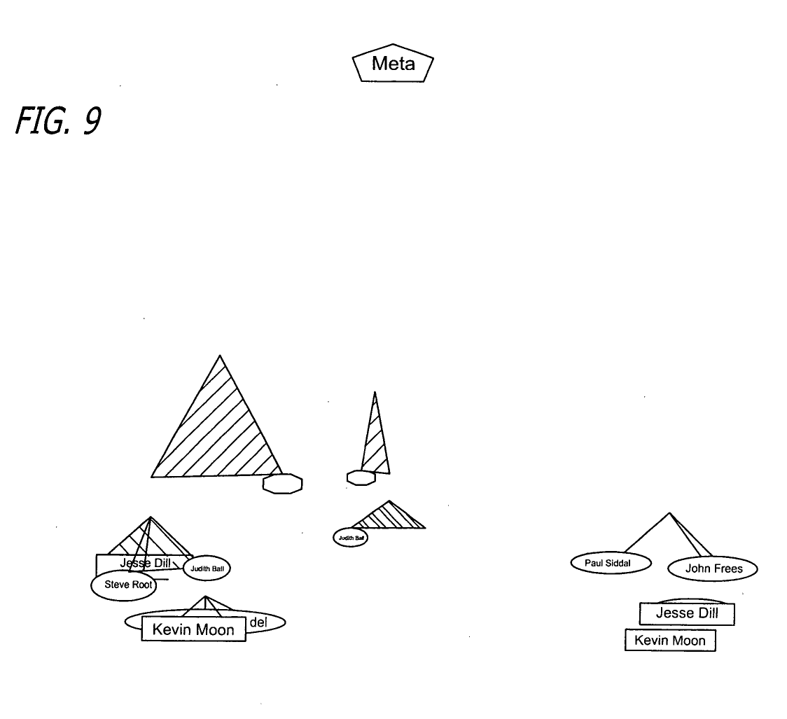

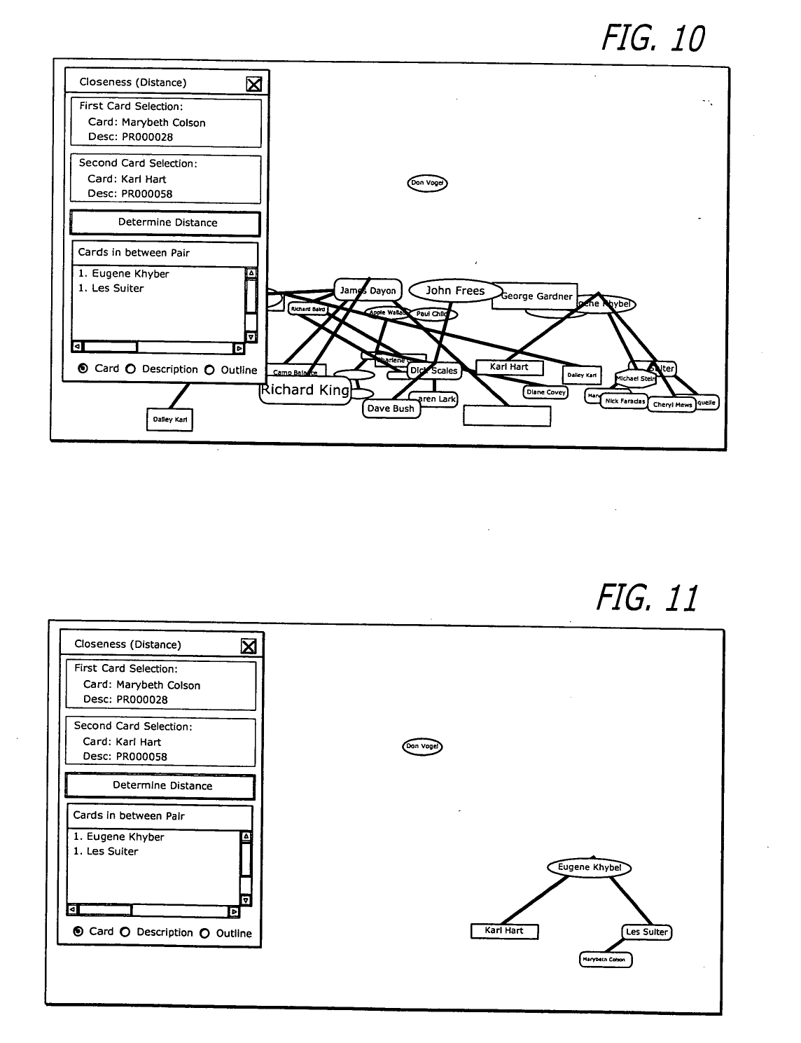

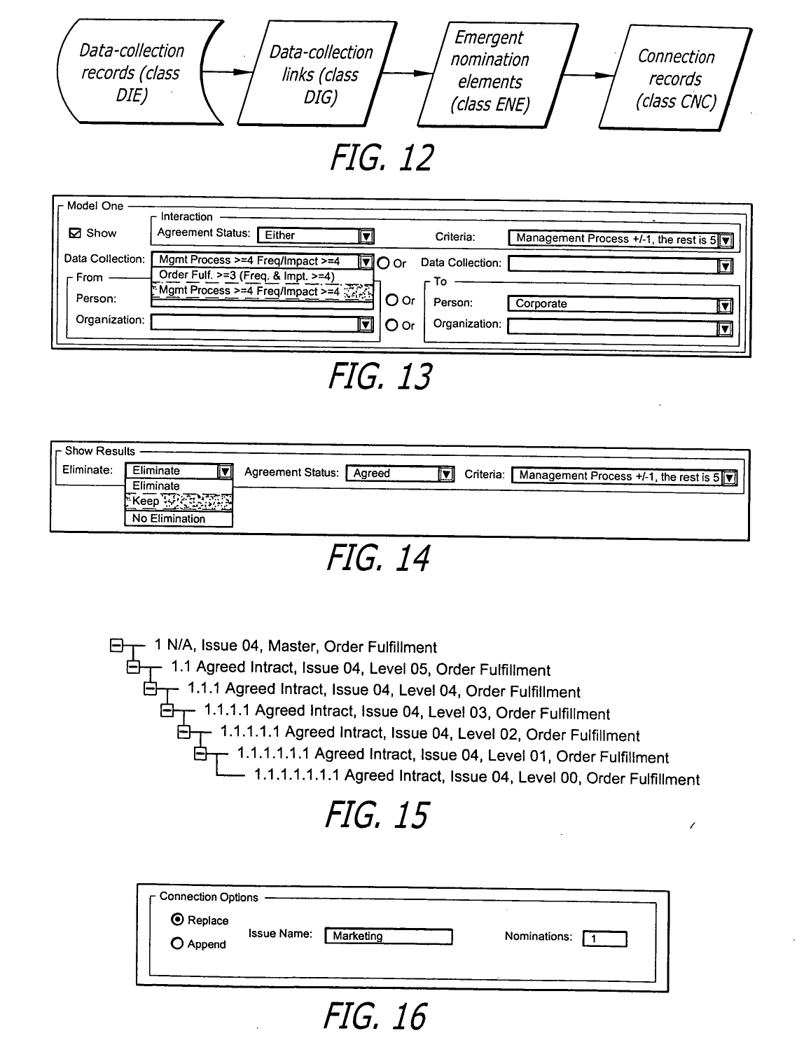

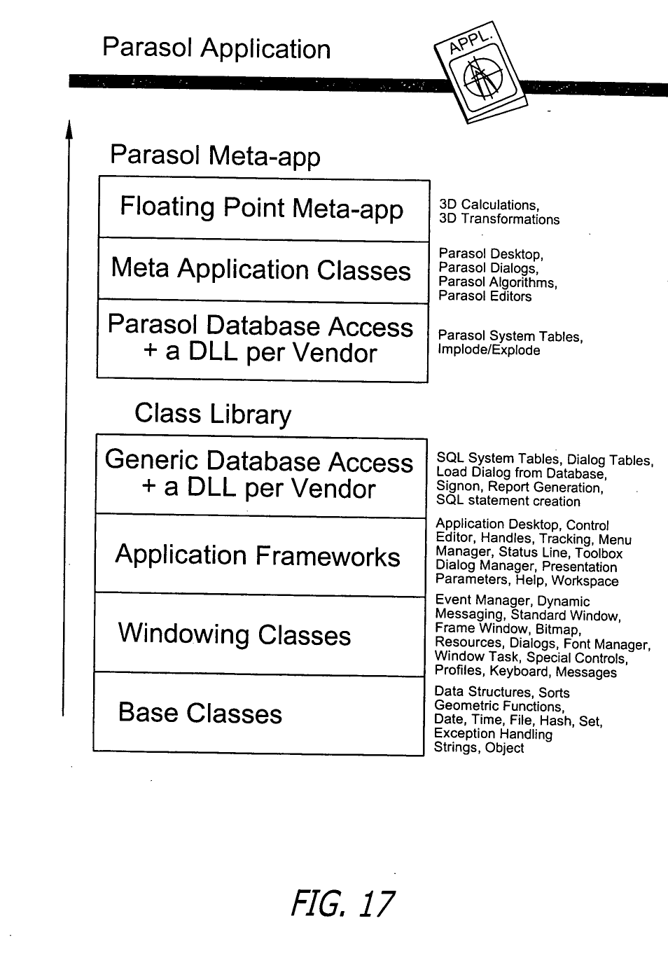

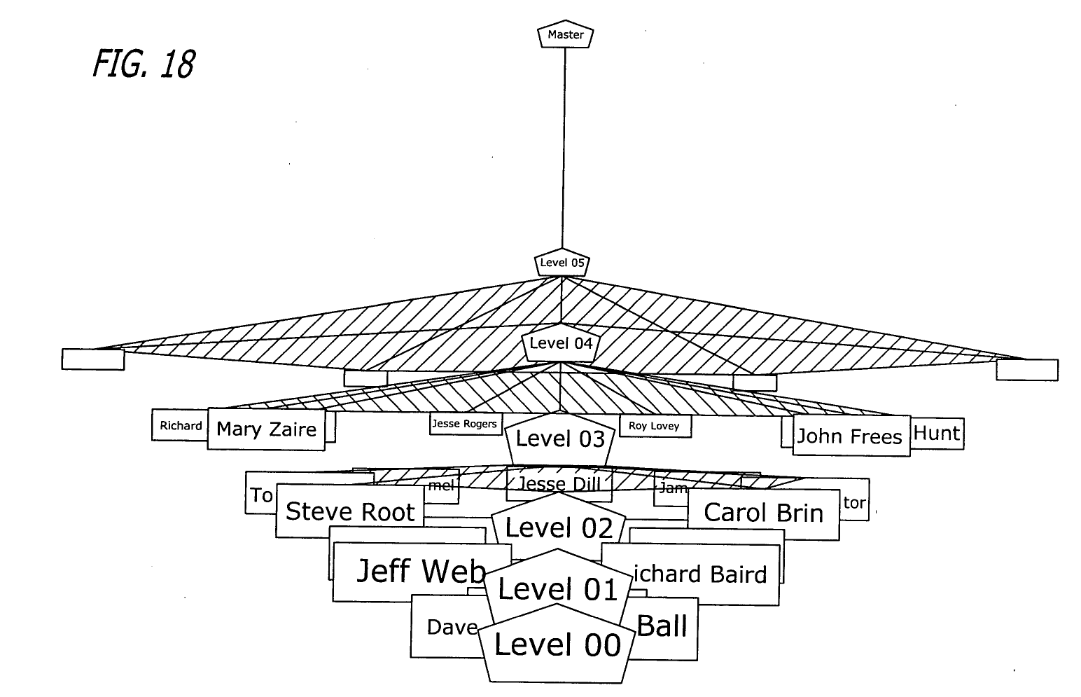

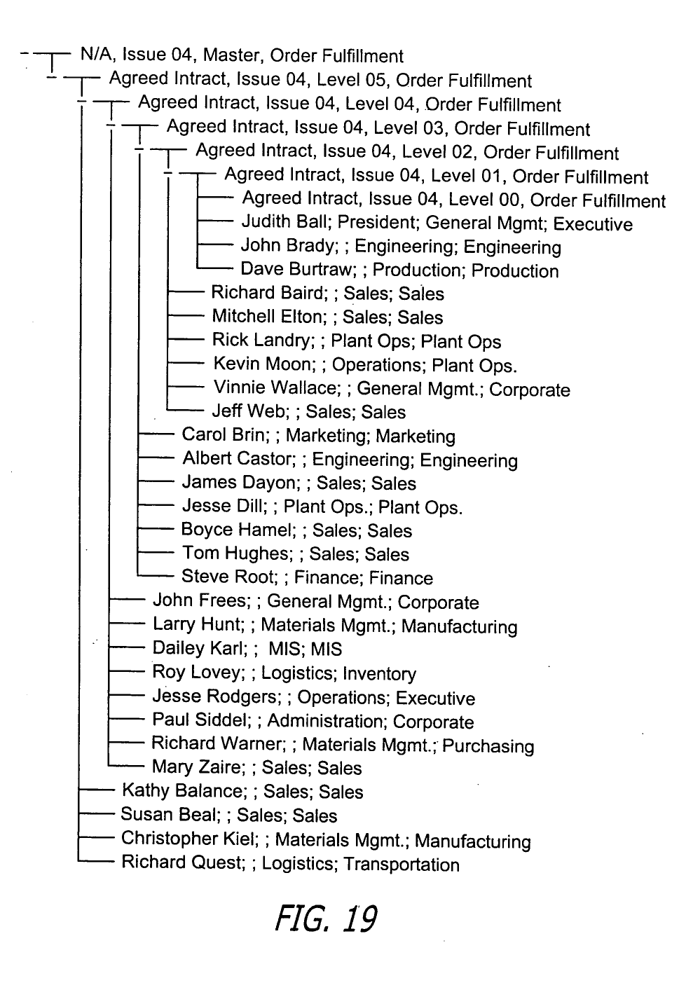

### DETAILED DESCRIPTION OF THE PREFERRED EMBODIMENTS

The emergent structure analysis of the present invention enhances a computer-supported tool for improved enterprise process analysis and change management. The new and improved system and method of the present invention collects data on the patterns of interaction among people in an organization, analyzes these relationships with respect to specific organizational processes and issues, and presents the results in a graphical format useful for business management organization decisions.

The emergent structure analysis is a selection and transformation process. Its data are the issues that have been defined as important for an organizational or system study and the organization members' reported perceptions of their regular interactions with others about those issues, as gathered by a specialized data collection instrument. According to criteria defined by an analyst using appropriate software in accordance with the invention, the process selects a subset of this raw data, creates a suitable structure, and connects each person record to its appropriate level in the structure.

More particularly, by way of example and not necessarily by way of limitation, the invention provides a basic system and method for visualizing interaction patterns, called the issue view. Rather than a fixed, formal hierarchy, this view displays interactions between members of an organization against the background of an emergent structure: that is, which arises from the significance that individual members assign to one another—specifically, their perceived impact on a given issue. In this view, a person's status may be quite different from his position in the organization's formal hierarchy and the view provides valuable insights into the real communication and decision-making patterns within an organization. The emergent structure analysis of the present invention is the system and set of business method procedures that creates these structures.

The standard issue emergent structure view presents a “virtual hierarchy” which emerges around a single issue: people in the organization appear at different levels depending on their perceived impact on that issue. It is often useful, however, to view and compare the emergent structures of more than one issue at the same time. For example, an analyst might want to see who are a company's important decision-making figures in the arenas of both sales and marketing, and investigate the communications links between those groups. To include multiple issues in the same view, practice of the invention provides the ability to create meta-issues. When the analyst wishes to study multiple issues, he or she creates a meta-issue entry in the database and manually connects the related master issues to it.

A “Show Duplicate Nodes” function is also provided and isolates any objects that appear more than once in the issue view display. This feature is useful when examining multiple-issue analyses involving meta-issues, where it is often important to verify that decision-making processes are well integrated across related issues. For example, the same decision-makers may need to be involved in both product design and cost planning. Conversely, in other cases, it may be advisable to ensure that the same individuals do not play a role in areas that should remain separate, such as corporate auditing and investment management.

When studying communication patterns among a group of people, an important concept is that of closeness: the distance between any two individuals, as expressed by the number of nodes between them. For the analyst, this measure reveals how closely two specific members of an organization are linked on a given issue—whether they communicate with each other directly, indirectly through intermediaries, or not at all. Unnecessary steps in the process can represent opportunities for information to be delayed or distorted, whereas direct communications that inappropriately bypass the chain of command and leave others “out of the loop” can subvert the aims of the organizational structure.

In many cases, a complex or crowded display can obscure the links between specific people Furthermore, they may be connected by multiple routes, some more direct than others, so that it becomes difficult to locate the shortest path between them. To find this information, the invention provides the Closeness function, which automatically calculates the displays the shortest path between any two nodes in the graphical analysis tree provided by the invention. Once the program has determined the shortest path between two nodes, the analyst can elect to subtract all other links from the display, thereby isolating the desired path.

All of the above and other features of the invention are facilitated by appropriate EnCompass® software for providing/enabling the functions in the illustrated and equivalent embodiments to “make it happen” in achieving new and improved business analysis and management systems utilizing emergent structures. “EnCompass®” is a registered trademark of EnCompass Knowledge Systems, Inc., Los Angeles, Calif., the company which has pioneered innovative tools for analysis of interactive relationships and organization/system dynamics.

The attached Exhibits A through H are provided in this application as explanatory of the preferred embodiments of the invention. These exhibits are:
Exhibit A—The EnCompass® Emergent Structure Analysis—65 pages;
Exhibit B—Parasol—Object-Oriented and Graphical Database Reference and Visualization—4 pages, double-sided;
Exhibit C—C+Objects—Volume One—Foundation Data Structures—8 pages, double-sided;
Exhibit D—Parasol Developer User Guide—bound;
Exhibit E—C+O Class Library Foundation Data Structures—OS/2 Version/Volume One User's Guide—bound;
Exhibit F—C+O Class Library Foundation Data Structures—OS/2 Version/Volume One Reference Manual—bound;
Exhibit G—Transmittal Letter for Compact Disc containing EnCompasse Program—6 pages.; and
Exhibit H—Two Compact Disc-Recordable (CD-R's) for EnCompass® Emergent Structure Analysis.

Of course, while the invention is described, by way of example, in the context of a business organization, the teachings of the invention may also be applicable to analysis of other systems and environments.

Examples of a preferred form of source code, for use in carrying out the above described software and firmware steps in conjunction with the hardware as described above in the practice of the present invention, are included in the CD-R as the official copy thereof which is a computer program listing appendix, and which is a part of this application and incorporated by reference herein.

It will be apparent from the foregoing that, while particular forms of the invention have been illustrated and described, various alternatives, modifications and variations can be made without departing from the spirit and scope of the invention. Accordingly, the invention is intended to embrace all such alternatives, modifications and variations and it is not intended that the invention be limited, except as by the appended claims.

1. In a system for enhanced business analysis and management, a combination comprising:
first means for defining the current status of complex system/organization relationships;
second means for defining the desired status of such a complex system/organization;
third means responsive to said first means and said second means for selection and transformation of data relating to issues and relationships in the system/organization to provide an output display in graphical format representing an emergent structure defining enhanced patterns of relationships.

2. In a business method for enhanced business analysis and management, the steps comprising:
defining the current status of complex system/organization relationships;
defining the desired status of such a complex system/organization;
selecting and transforming data relating to issues and relationships in the system/organization to provide an output display in graphical format representing an emergent structure for defining enhanced patterns of relationships.

3. Each and every novel feature and/or combination of novel features herein disclosed.
